(19) United States
(12) Patent Application Publication
(10) Pub. No.: US 2023/0311454 A1
(43) Pub. Date: Oct. 5, 2023

(54) HEAT BARRIER LAMINATE

(71) Applicant: COMMONWEALTH SCIENTIFIC AND INDUSTRIAL RESEARCH ORGANISATION, Acton, Australian Capital Territory (AU)

(72) Inventors: Ron DENNING, Acton, Australian Capital Territory (AU); Sharon EDWARDS, Acton, Australian Capital Territory (AU); Peter HERWIG, Acton, Australian Capital Territory (AU); Doug DOWER, Acton, Australian Capital Territory (AU); Paulo BORGES, Acton, Australian Capital Territory (AU); Michelina DEL GIUDICE, Acton, Australian Capital Territory (AU)

(21) Appl. No.: 17/920,906

(22) PCT Filed: Apr. 22, 2021
(86) PCT No.: PCT/AU2021/050359

§ 371 Date: Oct. 24, 2022

(30) Foreign Application Priority Data
Apr. 24, 2020 (AU) 2020901293

(51) Int. Cl. B32B 15/14; B32B 15/20

(52) U.S. Cl. CPC B32B 15/14; B32B 15/20; B32B 5/026; B32B 2255/02; B32B 2255/26; B32B 2307/304; B32B 2307/7376

(57) ABSTRACT

A heat barrier laminate for use as a skin, the laminate comprising in the following order: a) a radiant barrier layer, b) a heat-insulating layer comprising a first polymer, c) a spacer layer comprising a fabric, and d) a heat-insulating layer comprising a second polymer, wherein the first polymer and/or the second polymer comprise a heat-insulating filler selected from hollow glass particles, hollow ceramic particles, hollow polymer particles, and a combination thereof.

### FIELD OF THE INVENTION

The present invention relates generally to heat barrier laminates, and in particular to a heat barrier laminate for use as a skin.

### BACKGROUND ART

Conventional protective skins for manufactured components, for instance electronic, mechanical, or robotic components such as robotic arms used in industry, are primitive, disposable and not suitable for use in extreme environmental conditions such as high temperature and hazardous substances. These conventional covers are typically made from either nonwoven or woven polyethylene. Although strong and tough, those covers are typically poorly fitted to the component and are not able to withstand exposure to extreme environments.

Other conventional skins include an array of sensors capable to detect external conditions (e.g. tactile and infrared sensors). In case of a robotic component, the sensors provide the input to drive the robot away from hazardous environments. By their own nature, those skins are not designed to protect a component from direct exposure to extreme conditions, and are therefore unsuited to protect components intended to operate in hostile environments (e.g. rescue robots).

Overall, conventional protective skins for manufactured components such as robotic components are either heavy, which limits the working time of the component, or give inadequate protection against the environment, affording very short operating times in extreme environments.

There remains therefore an opportunity to address or ameliorate one or more disadvantages or limitations of protective skins for manufactured components, for example conventional robot protective skins, or to provide at least a useful alternative.

### SUMMARY OF THE INVENTION

The present invention provides a heat barrier laminate for use as a skin, the laminate comprising in the following order:
a) a radiant barrier layer,
b) a heat-insulating layer comprising a first polymer,
c) a spacer layer comprising a fabric, and
d) a heat-insulating layer comprising a second polymer,
wherein the first polymer and/or the second polymer comprise a heat-insulating filler selected from hollow glass particles, hollow ceramic particles, hollow polymer particles, and a combination thereof.

The combined function of the specific sequence of layers of the present invention can make the laminate advantageously heat- and flame-resistant, impervious to fluids (e.g. waterproof), inert to hazardous substances, and resistant to tear and mechanical shock. In addition, the layers can be tailored to have very low density, making the laminate advantageously lightweight.

By being a “heat barrier”, the laminate of the present invention will be understood to be one that combines a thermal conductivity of less than 0.025 W/m·K and a material density of less than 1,000 kg/m³. Under those conditions, it is expected the laminate would protect from continuous direct contact to a live flame for at least 30 minutes. Typically, the laminate will be capable to withstand heat intensities (heat flux) of at least 50 kW/m² at flashover. By “flashover” is meant the near-simultaneous ignition of most combustible material directly exposed to fire in an enclosed area.

In some embodiments, the first polymer and/or the second polymer is/are an elastomer. For example, silicone may be a suitable elastomer in that regard, providing for a flexible and elastic laminate that is ideally suited for use a skin in component parts capable of relative movement, for example robotic junctions, without hindering motion. In addition, the use of an elastomer (e.g. silicone) as the first and/or second polymer advantageously confers the laminate with significant tear and shock resistance.

The first polymer and/or second polymer comprise(s) a heat-insulating filler selected from hollow glass particles, hollow ceramic particles, hollow polymer particles, and a combination thereof. For example, the first polymer and/or second polymer comprise(s) a heat-insulating filler selected from hollow glass microspheres, hollow ceramic microspheres, hollow polymer microspheres, and a combination thereof. Also described is a heat-insulating filler which is an aerogel filler. The resulting laminate can advantageously combine very low density (e.g. less than 500 kg/m³) and high heat-insulating capability (e.g. a thermal conductivity of less than 0.02 W/m·K), making the laminate particularly suited to protect against particularly extreme environments. This makes the laminate particularly useful for example, as protective skin for rescue robots in disaster areas (earthquake, bushfires, and house fires). Advantageously, these laminates can withstand radiant heat (heat flux) of at least 100 kW/m² at flashover.

Accordingly, in certain aspects, the present invention relates also to a laminate for use as a skin on a robotic component.

In another aspect, the invention also relates to a skin for a robotic component, the skin comprising a laminate of the kind described herein.

Further aspects and/or embodiments of the invention are outlined below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention will be now described with reference to the following non-limiting drawings, in which:

FIG. 1 shows a cross-section schematic of a laminate in accordance with an embodiment of the invention,

FIG. 2 shows temperature profiles measured at the opposed surfaces of an embodiment laminate exposed to a heat flux of 20 kW/m², as described in Example 4,

FIG. 3 shows temperature profiles measured at the opposed surfaces of an embodiment laminate exposed to a heat flux of 20 kW/m², as described in Example 5,

FIG. 4 shows temperature profiles measured at the opposed surfaces of an embodiment laminate exposed to a heat flux of 20 kW/m², as described in Example 6,

FIG. 5 shows temperature profiles measured at the opposed surfaces of an embodiment laminate exposed to a heat flux of 20 kW/m², as described in Example 7,

FIG. 6 shows (a) a picture of a laminate used as partial skin covering the leg portion of a robot, the laminate being made from 2 mm Soft Trans 15 filled with 5% XOL microspheres (white aluminosilicate multicellular hollow spheres) and 10 % aluminium flakes, and (b) the temperature profile measured at the non-exposed surface of the skin exposed to a heat flux of 20 kW/m², as described in Example 8, and

FIG. 7 shows Scanning Electron Microscopy (SEM) images of (a) an internal portion of foamed silicon used as the polymer in an embodiment laminate, and (b) a cross-section of the silicon-fabric interface of an embodiment laminate.

### DETAILED DESCRIPTION OF THE INVENTION

The present invention relates to a heat barrier laminate, which is for use as a skin.

As used herein, the term “laminate” means a structure comprising a plurality of layers. The layers may or may not be bonded together. By the laminate being for use as a “skin”, the laminate is intended to function as a cover element constituting an outer layer of a manufactured component, for example a mechanic and/or electric/electronic component, that separates at least a portion of the component from the external environment.

Examples of manufactured components in that regard include any manufactured component that needs protection against heat and/or direct exposure to fire. Those may include batteries, fuel cells, electric and electronic circuitry and components, mechanical parts, and robotic components.

By being a “heat barrier”, the laminate of the present invention will be understood to be one that combines a thermal conductivity of less than 0.025 W/m·K and a material density of less than 1,000 kg/m³. Under those conditions, it is expected the laminate would protect a component from continuous direct contact to a live flame for at least 30 minutes. Typically, the laminate will be capable to withstand heat intensities (heat flux) of at least 50 kW/m² at flashover.

The laminate of the invention comprises a radiant barrier layer a).

By acting as “radiant barrier”, the layer is capable to reflect radiant heat to reduce radiative transfer of thermal energy. Typically, the radiant barrier layer would be made of a radiant barrier material with an emissivity of less than 0.3 at a peak wavelength in the infrared spectrum (i.e. 700 nm - 1 mm). In some embodiments, the radiant barrier layer has emissivity of less than 0.1, less than 0.075, less than 0.05, or less than 0.025 at a peak wavelength in the infrared spectrum.

In some embodiments, the radiant barrier material is a radiant barrier metal. Examples of radiant barrier metals suitable for use in the laminate of the invention include aluminium, silver, copper, gold, an alloy thereof, and a combination thereof. In some embodiments, the radiant barrier metal is selected from aluminium and an aluminium alloy.

The radiant barrier layer may be provided in any form that is suitable for its purpose. For example, the radiant barrier layer may be provided in the form of a foil. By being in the form of a “foil”, the radiant barrier layer is in the form of a sheet of material which thickness is orders of magnitude smaller than its other two dimensions. In those instances, the radiant barrier layer advantageously combines protection from thermal radiation, light-weightiness and flexibility. This is particularly advantageous to protect small mechanical and/or electronic components having joined elements that can operate in relative motion, such as in robots or robotic components, without hindering motion.

In some embodiments, the radiant barrier layer is in the form of a foil with a thickness of less than about 1 mm, less than about 0.75 mm, less than about 0.5 mm, less than about 0.25 mm, less than about 0.1 mm, less than about 0.05 mm, less than about 0.025 mm, or less than about 0.01 mm.

In some embodiments, the radiant barrier layer is aluminium foil.

The laminate of the invention also comprises a heat-insulating layer b) comprising a first polymer (also referred herein as “heat-insulating layer b)”).

By the layer being “heat-insulating”, the layer slows conduction and convection of thermal energy through its thickness. Typically, the heat-insulating layer in the laminate of the invention would have a thermal conductivity of about 0.3 W/m·K or less at 25° C. Accordingly, in some embodiments, the heat-insulating layer b) has a thermal conductivity of less than about 0.3 W/m·K, less than about 0.25 W/m·K, less than about 0.2 W/m K, less than about 0.1 W/m·K, less than about 0.075 W/m·K, less than about 0.05 W/m·K, less than about 0.025 W/m·K, or less than about 0.02 W/m·K, at 25° C.

Values of thermal conductivity (and corresponding specific thermal resistivity) used herein have been determined using testing apparatus and procedures in accordance with the requirements of ISO 6942.

The first polymer may be any polymer providing the heat-insulating layer with the required thermal conductivity characteristics. In some embodiments, the first polymer is an elastomer. Any elastomer that is fit for purpose may be used as the first polymer. Examples of suitable elastomers in that regard include butyl rubbers, fluoro elastomers, natural rubber (vulcanized and unvulcanised), neoprene, nitrile, polyurethane, silicone, and a combination thereof. In some embodiments, the first polymer comprises silicone.

In some embodiments, the first polymer is a foamed polymer. Any foamed polymer having the required thermal conductivity characteristics may be suitable for use in the heat-insulating layer of the laminate. In some embodiments, the foamed polymer is selected from foamed silicone, foamed neoprene, foamed polyurethane, and a combination thereof. A skilled person would be aware of procedures for obtaining foamed polymers for the purpose of the present invention, for example using a blowing agent (such as 2,2′-azobis(isobutyronitrile)) during polymerisation.

In the laminate of the invention, the first polymer and/or the second polymer comprise a heat-insulating filler selected from hollow glass particles, hollow ceramic particles, hollow polymer particles, and a combination thereof. In other words, at least one of the first polymer and the second polymer comprise a heat-insulating filler selected from hollow glass particles, hollow ceramic particles, hollow polymer particles, and a combination thereof.

According to certain aspects of the invention, the first polymer comprises a heat-insulating filler selected from hollow glass particles, hollow ceramic particles, hollow polymer particles, and a combination thereof.

Typically, the heat-insulating filler can be blended within the polymer and have a lower thermal conductivity relative to the polymer. As such, by the polymer comprising a heat-insulating filler selected from hollow glass particles, hollow ceramic particles, hollow polymer particles, and a combination thereof, the polymer has a lower thermal conductivity than the polymer absent the filler. In some embodiments, the heat-insulating filler has a thermal conductivity of less than 0.25 W/m·K, less than 0.1 W/m·K, or less than 0.05 W/m·K at 25° C. (as the thermal conductivity of air is about 0.0267 W/m·K).

Any heat-insulating filler selected from hollow glass particles, hollow ceramic particles, hollow polymer particles, and a combination thereof, and having the required thermal characteristics may be used for the purpose of the invention.

The heat-insulating filler comprises at least one of hollow glass particles, hollow ceramic particles, and hollow polymer particles. As a skilled person would know, a “hollow” particle is a particle made of a shell material enclosing an internal void, the void typically being air or a gas. Presence of hollow particles is particularly advantageous in that those particles can contribute to the reduction of both the thermal conductivity and the density of the polymer relative to the polymer absent the particles.

Provided they have the required thermal conductivity characteristics, any hollow glass particles (e.g. hollow silica particles), hollow ceramic particles, or hollow polymer particles may be used for the purpose of the invention. Those skilled in the art would know of suitable procedures for the production of hollow particles suitable for use in the laminate of the invention.

The hollow glass particles, hollow ceramic particles, or hollow polymer particles may be of any size conducive to the intended function of the particles. Typically, the hollow glass particles, hollow ceramic particles, or hollow polymer particles would be characterised by an average major dimension in the range of from about 1 µm to about 500 µm. In some embodiments, the hollow glass particles, hollow ceramic particles, or hollow polymer particles have an average major dimension of at least about 1 µm, at least about 2 µm, at least about 5 µm, at least about 10 µm, at least about 25 µm, at least about 50 µm, at least about 100 µm, or at least about 200 µm. In some embodiments, the hollow glass particles, hollow ceramic particles, or hollow polymer particles have an average major dimension in the range of from about 1 µm to about 300 µm, from about 1 µm to about 200 µm, from about 1 µm to about 150 µm, from about 1 µm to about 100 µm, or from about 1 µm to about 50 µm.

The hollow glass particles, hollow ceramic particles, or hollow polymer particles may be of any shape or dimension suited for their intended purpose. In some embodiments, the hollow glass particles, hollow ceramic particles, or hollow polymer particles have a substantially spherical shape. By having a “substantially spherical shape”, the particles have either the shape of a sphere or a round spherical shape that approximates that of a sphere. In those instances, the particles may have an average diameter in the dimensional ranges described herein. In some embodiments, the hollow glass particles, hollow ceramic particles, or hollow polymer particles are microspheres. In those instances, the heat-insulating filler is therefore selected from hollow glass particles, hollow ceramic particles, hollow polymer particles, and a combination thereof.

Also described herein is a heat-insulating filler that comprises an aerogel. As used herein, the term “aerogel” refers to an open-celled, mesoporous, solid foam material that is composed of a network of interconnected nanostructures and that exhibits a porosity (i.e. non-solid volume) of no less than 50% by volume. The term “mesoporous” refers to a material that contains pores ranging from 2 to 50 nm in average dimension. Typically, most aerogels exhibit between 90 to 99.8+% porosity (by volume) and also contain a significant fraction of micropores (i.e. pores less than 2 nm in average dimension). As a result, aerogels can have extremely low thermal conductivity, typically from 0.03 W/m·K down to 0.004 W/m·K at 25° C.

A skilled person would have knowledge of aerogels, and would be capable to readily devise procedures to fabricate an aerogel suitable for use in the laminate of the invention. Suitable procedures in that regard, for example, involve the controlled isolation of a solid framework of a gel from its liquid component under supercritical drying conditions.

Suitable aerogels may be aerogels of any material that can be made in aerogel form. Examples of suitable materials in that regard include silica, transition metal oxides, lanthanide and actinide metal oxides, main group metal oxides (e.g. tin oxide), organic polymers (e.g. resorcinol-formaldehyde, phenol-formaldehyde, polyacrylates, polystyrenes, polyurethanes, and epoxies), biological polymers (such as gelatin, pectin, and agar agar), semiconductor nanostructures (such as cadmium selenide quantum dots), and carbon (including carbon nanotubes).

The aerogel may be silica aerogel. In those instances, the aerogel may be characterised by a thermal conductivity in the range of 0.004-0.04 W/m·K at 25° C.

The aerogel may be used in any form and dimension compatible with the aerogel being blended within the polymer. For example, the aerogel may be in the form of particles, flakes, etc. In those instances, the aerogel may have an average major dimension within the dimensional ranges described herein.

In some embodiments, the heat-insulating filler comprises a low-density inorganic material, for example expanded perlite, sepiolite, closed-cell perlite, diatomaceous earth, or a combination thereof.

The polymer may contain any amount of heat-insulating filler that would be suitable for the purpose of the laminate, provided the mechanical stability of the laminate is not compromised. For example, the polymer may contain an amount of heat-insulating filler of about 1-40 wt.%, about 1-30 wt.%, about 1-20 wt.%, about 1-10 wt.%, or about 1-5 wt.%, relative to the weight of the polymer. In some embodiments, the polymer may contain an amount of heat-insulating filler of about 5 wt.% relative to the weight of the polymer.

In some embodiments, the first polymer comprises a heat-reflecting filler. Functionally, a heat-reflecting filler would be a filler material that can reflect radiant heat to reduce radiative transfer of thermal energy. Advantageously, presence of a heat-reflecting filler within the polymer enhances the thermal radiative characteristics of the heat-insulating layer, adding to the radiative protection afforded by the radiant barrier layer.

Typically, the heat-reflecting filler would be made of a radiant barrier material with an emissivity of less than 0.3 at a peak wavelength in the infrared spectrum (i.e. 700 nm - 1 mm). In some embodiments, the heat-reflecting filler has emissivity of less than 0.1, less than 0.075, less than 0.05, or less than 0.025 at a peak wavelength in the infrared spectrum. Being a “filler”, the heat-reflecting filler may be provided in any form that would make it suitable to be blended within the polymer. For example, the heat-reflecting filler may be in the form of particles, flakes, etc.

The heat-reflecting filler may be made of any heat-reflecting materials. For example, the heat-reflecting filler may be made of a heat-reflecting material of the kind described herein.

In some embodiments, the heat-reflecting filler is a metal filler. For example, the heat-reflecting filler may comprise an aluminium filler. In some embodiments, the aluminium filler is selected from aluminium flakes, aluminium powder, and a combination thereof.

In some embodiments, the heat-reflecting filler comprises a metal oxide filler. For example, the heat-reflecting filler may be selected from Fe₂O₃, MnO₂, Cr₂O₃, TiO₂, SiO₂, Al₂O₃, La₂O₃, CeO, and a combination thereof.

The polymer may contain any amount of heat-reflective filler that would be suitable for the purpose of the laminate, provided the mechanical stability of the laminate is not compromised. For example, the polymer may contain an amount of heat-reflective filler of about 1-40 wt.%, about 1-30 wt.%, about 1-20 wt.%, about 1-10 wt.%, or about 1-5 wt.%, relative to the weight of the polymer. In some embodiments, the polymer contains an amount of heat-reflective filler of about 1-20 wt% relative to the weight of the polymer. In some embodiments, the polymer contains an amount of heat-reflective filler of about 10% wt relative to the weight of the polymer.

The heat-insulating layer b) may have any thickness that is conducive to the layer providing the required heat-insulation effect. In some embodiments, the heat-insulating layer b) has a thickness of about 1-25 mm, about 8-12 mm, or about 6-10 mm. In some embodiments, the heat-insulating layer b) has a thickness of between about 8 mm and about 12 mm.

The laminate of the invention also includes a spacer layer c) comprising a fabric.

By being a “spacer” fabric, the fabric introduces a degree of insulating air between the heat-insulating layers. Advantageously, this contributes to further lowering the thermal conductivity of the laminate. Additionally, the fabric can contribute to the flexibility of the laminate while maintaining mechanical stability.

The fabric may be provided in any form that would be suitable for the intended purpose. In that regard, the fabric may be woven (e.g. knitted) or non-woven fabric. In addition, the fabric may be a single layer fabric or multiple-layer fabric. In some embodiment, the fabric is woven fabric. In some embodiments, the fabric is non-woven fabric.

In the case of multiple-layer fabric, each layer may be periodically interconnected to one another throughout the fabric, with the distance between these connections (measured in weft picks per inch) varied, and the density of the weft stitch within these areas (measured in weft picks per inch) varied to obtain the desired interconnection pattern. In some embodiments, the fabric is selected from a single layered woven, a double layer woven, and a triple-layered woven. In some instances, one or more fabric extension(s) may exist in places where the layers are not interconnected, permitting greater extension than an interconnected woven structure. The degree of interconnection between each layer may be modulated to provide suitable spacing between each layer. In some embodiments, the fabric is a multi-layer fabric having each layer interconnected at a distance of 20/2, 24/2, 28/2, 32/3, 42/3, or 54/3 weft picks per inch (PPI).

In some embodiments, the fabric comprises a rippled portion, in which a yarn is periodically inserted as a weft yarn to create a rippled effect. In those instances, the resulting fabric has improved flexibility relative to a fabric with no rippled effect. The rippled effect may be obtained by using an interconnecting weft at an interconnecting weft density of 48, 64, 80, 90, 94, 102, 110 weft picks per inch (PPI) in order to obtain the desired ripple patterns. In some embodiments, the fabric comprises cotton/lycra yarn within the fabric structure, in which the cotton/lycra yarn has been periodically inserted as a weft yarn to create the rippled effect.

The fabric may be characterised by any value of grammage that would be conducive of the fabric performing its intended function. As would be known to the skilled person, the “grammage” is a measure of the areal density of a fabric product, that is, its mass per unit of area. Typically, the grammage is expressed in terms of grams per square metre, or “gsm”. Suitable values of fabric grammage for the purpose of the invention fall within the range of 30-400 gsm. In some embodiments, the fabric has a grammage of at least about 30 gsm, at least about 50 gsm, at least about 100 gsm, at least about 150 gsm, at least about 250 gsm, or at least about 300 gsm. In some embodiments, the fabric has a grammage in the range of about 30-300 gsm, about 30-250 gsm, about 30-200 gsm, about 30-150 gsm, or about 30-100 gsm. In some embodiments, the fabric has a grammage of about 200 gsm.

The fabric may be made of any fibre material that would be suitable to obtain a spacer layer having the intended function.

In some embodiments, the fabric is made of a flame-resistant fibre material. By being “flame-resistant”, the fibre material is characterised by a limiting oxygen index (LOI) of at above 21%. In some embodiments, flame-resistant fibre material suitable for use in the fabric of the laminate include fibres would have a limiting oxygen index (LOI) greater than 26 vol%, for example greater than 30 vol%. In some embodiments, the fibre material is selected from cellulose, a non-aromatic polyamide, a meta-aramid, a para-aramid, and a combination thereof. In some embodiments, the fibre material is selected from a meta-aramid (e.g. Nomex) and a para-aramid (e.g. Kevlar). Examples of suitable fibre materials for use in the invention include wool, modacrylic, polyvinyl chloride (PVC), polyvinylidene dichloride (PVDC), polytetrafluoroethylene (PTFE), oxidised acrylic, Nomex, Kevlar, polybenzimidazole (PBI), and a blend thereof.

The spacer layer may have any thickness that would be suitable for the intended use of the laminate. In some embodiments, the spacer layer has an average thickness of at least about 5 mm, at least about 7.5 mm, at least about 10 mm, at least about 12 mm, or at least about 50 mm. In some embodiments, the spacer layer has an average thickness of about 10 mm.

The laminate of the invention also comprises a heat-insulating layer d) comprising a second polymer.

The second polymer may be any of the polymer is described herein in relation to the heat-insulating layer b). In some embodiments, the first polymer and the second polymer are the same polymer.

The combination of layers a)-d) of the kind described herein is believed to be unique in its own right. Accordingly, the present invention may also be said to provide a heat barrier laminate for use as a skin, the laminate comprising in the following order: a) a radiant barrier layer, b) a heat-insulating layer comprising a first polymer, c) a spacer layer comprising a fabric, and d) a heat-insulating layer comprising a second polymer. Each one of layers a)-d) may be a layer of the kind described herein.

According to certain aspects of the invention, the second polymer comprises a heat-insulating filler selected from hollow glass particles, hollow ceramic particles, hollow polymer particles, and a combination thereof. The hollow glass particles, hollow ceramic particles, or hollow polymer particles may be particles of the kind described herein. The second polymer may contain the heat-insulating filler in an amount described herein.

In accordance to certain aspects of the invention, both the first polymer and the second polymer comprise a heat-insulating filler selected from hollow glass particles, hollow ceramic particles, hollow polymer particles, and a combination thereof. The hollow glass particles, hollow ceramic particles, or hollow polymer particles may be particles of the kind described herein. Each of the first polymer and the second polymer may independently contain the heat-insulating filler in an amount described herein.

In some embodiments, the second polymer comprises a heat-reflecting filler. For example, the second polymer may comprise a heat-reflecting filler of the kind described herein. Also, the second polymer may contain a heat-reflecting filler according to any of the amounts described herein.

The heat-insulating layer d) may have any thickness that is conducive to the laminate functioning as intended. For example, the heat-insulating layer d) may have a thickness of about 1-25 mm, about 1-15 mm, or about 1-10 mm. In some embodiments, the heat-insulating layer b) has a thickness of between about 1 mm and about 5 mm.

The collective arrangement of the layers provide the laminate with a thickness resulting from the sum of thicknesses of each layer. Accordingly, in some embodiments the laminate of the invention has a total thickness of between about 10 mm to about 30 mm. In some embodiments, the laminate has a total thickness of between about 10 mm to about 20 mm. When the total thickness of the laminate is in the range of 10-20 mm, the laminate is characterised by a particularly advantageous combination of heat barrier capability and mechanical flexibility. In those instances, the laminate is particularly suitable for use as a skin on a robotic component that can perform complex movements.

In some embodiments, the density of each layer is such that the laminate has an average density of less than about 500 kg/m³.

In some embodiments, the thermal conductivity of each layer is such that the laminate has a combined thermal conductivity of less than about 0.025 W/m·K. In those instances, the laminate of the invention is advantageously capable of withstanding a heat intensity (heat flux) of at least 50 kW/m² at flashover. In some embodiments, the laminate can withstand heat intensity (heat flux) of at least 100 kW/m² at flashover.

Depending on the nature, thickness, and density of each layer, the laminate of the invention may be rigid or flexible. In some embodiments, the laminate of the invention is flexible. The skilled person would know how to layer thickness to ensure flexibility of the resulting laminate.

In some embodiments, flexibility of the laminate derives from the laminate being provided in a flexible shape. For example, the laminate may be shaped as a concertina fold.

Specific combinations of layers provide for laminates that advantageously combine high heat resistance, flexibility, and light weightiness. In that regard, particularly advantageous embodiment laminates follow.

Each layer of the laminate may be either physically stacked on a subsequent layer, or bonded to it.

In some embodiments, at least one of the layers a)-d) is physically stacked on a subsequent layer. For example, a radiant barrier layer a) (for example in the form of a thin foil, such as aluminium foil) may be stacked on heat barrier layer b) (for example in the form of a silicone layer of the kind described herein). In addition, the spacer layer c) may be merely sandwiched between the two heat-insulating layers b) and d), none of the layers being bonded to one another.

In some embodiments, at least one of the layers a)-d) is bonded to a subsequent layer. By a layer being “bonded” to another layer, the two layers are attached to one another to impede relative movement of the layers. Any form of bonding known to the skilled person would be suitable in that regard, provided the resulting laminate performs its intended function. In that regard, the bonding may be physical or chemical.

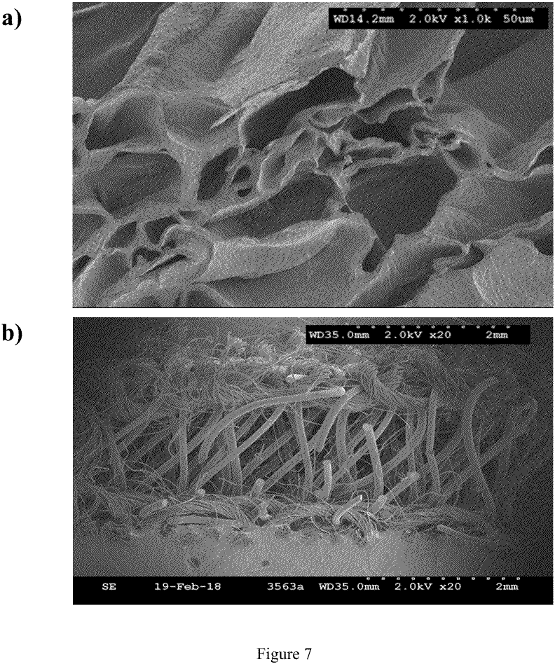

For example, the spacer layer may be physically bonded to either (or both) the first and second polymer forming the heat-insulating layers by impregnating a superficial portion of the fabric with polymer precursors in liquid form (e.g. a mixture of monomers or partially polymerised monomers), and subsequently promoting polymerisation of the polymer precursors such that the resulting polymer forms around the fibres of the fabric, physically locking the fibres within the polymer. An example of such interfacial bonding is shown in FIG. 7(b).

In alternative bonding procedures, adhesives may be used to provide a chemical bond between at least two layers. A skilled person would be capable to readily identify suitable adhesive materials and procedures to perform such bond.

### Embodiment Laminate 1

A laminate obtained by combining, in the following order:
a) a radiant barrier layer in the form of aluminium foil,
b) a heat-insulating layer comprising silicone containing hollow silica glass microspheres and aluminium flakes,
c) a spacer layer comprising flame-retardant fabric (e.g. Nomex), and
d) a heat-insulating layer comprising silicone containing hollow glass microspheres.

### Embodiment Laminate 2

A laminate obtained by combining, in the following order:
a) a radiant barrier layer in the form of aluminium foil,
b) a heat-insulating layer comprising silicone containing about 5 wt.% hollow silica glass microspheres, and having a thickness in the range of about 6-10 mm,
c) a spacer layer comprising a 200 gsm lightly punched non-woven Nomex fabric having thickness of about 10 mm, and
d) a heat-insulating layer comprising silicone containing about 5 wt.% silica glass microsphere, and having a thickness of about 2 mm.

### Embodiment Laminate 3

A laminate obtained by combining, in the following order:
a) a radiant barrier layer in the form of aluminium foil,
b) a heat-insulating layer comprising silicone foam,
c) a spacer layer comprising a 200 gsm lightly punched non-woven Nomex fabric having thickness of about 10 mm, and
d) a heat-insulating layer comprising silicone containing about 5 wt.% silica glass microsphere, and having a thickness of about 2 mm.

The laminate of the invention can be for use as a skin on a robotic component. Accordingly, some aspects of the present invention relate to a heat barrier laminate for use as a skin on a robotic component, the laminate comprising in the following order: a) a radiant barrier layer, b) a heat-insulating layer comprising a first polymer, c) a spacer layer comprising a fabric, and d) a heat-insulating layer comprising a second polymer. The radiant barrier layer, the heat-insulating layer, the spacer layer, and the heat-insulating layer may be a radiant barrier layer, a heat-insulating layer, a spacer layer, and a heat-insulating layer of the kind described herein, respectively.

As used herein, the expression “robotic component” means any mechanical and/or electronic part of an assembly of mechanical parts that is capable of automatic collective movement. Accordingly, a “skin” of the robotic component will be understood to be a cover element that separates at least a portion of the robotic component from the external environment.

In the context of the present invention, a heat barrier laminate would therefore be one that can protect a robotic component by combining a thermal conductivity of less than 0.025 W/m·K and a material density of less than 1,000 kg/m³. Under those conditions, it is expected the laminate would protect the mechanical and electronic parts of a robot from continuous direct contact to a live flame for at least 30 minutes. Typically, the laminate will be capable to withstand heat intensities (heat flux) of at least 50 kW/m² at flashover.

In use as skin on a component, such as a robotic component, it will be understood that the laminate of the invention can be designed to be removably attached to the component. This ensures that the laminate can be detached from the component, for instance in case it needs to be substituted after use, if damaged, or if a laminate with different characteristics is needed. In addition, removal of the laminate would facilitate access to the component, for example for maintenance. Accordingly, in some embodiments the laminate is one for a detachable skin.

According to a further aspect of the invention, there is also provided a skin for a robotic component, the skin comprising a laminate of the kind described herein. Due to the specific characteristics of the laminate, the skin can be highly insulating, impervious to fluids, chemically inert, and capable to withstand exposure to temperatures up to 1,900° C. for prolonged periods. This makes the skin of the invention particularly suited to protect robots that operate in harsh environmental conditions, for example in the presence of toxic/corrosive substances (e.g. liquids or gases) and high temperatures (e.g. during a fire).

The skin may be customized to enable a robot to perform specific tasks. For example, the skin may incorporate one or more sensors capable to detect and monitor parameters of interest (e.g. pressure, temperature, magnetic fields, chemical substances, etc.). The sensors may direct the robot to perform specific tasks based on environmental parameters.

Advantageously, the skin can be made to combine light-weightiness, flexibility, and mechanical resistance, providing the robotic component with additional protection against impact damage. The skin would fulfil its primary purpose of heat-protection and protection against other harsh environmental conditions to preserve the electronics and mechanical components of the robot, while allowing the full range of sensors to operate without restricting movement or maneuverability. Protecting these robot component parts will increase the operating time of the robots in the harsh, hazardous environments.

As discussed herein, the laminate may be designed such that the skin is detachable from the robotic component.

Based on the subject matter described herein, a skilled person would be capable to readily devise procedures for the fabrication of suitable heat barrier laminates for the purpose of this invention.

The invention is also described with reference to the following non-limiting examples.

### EXAMPLES

### Example 1

### Thermal Conductivity Testing

The thermal conductivity of sample laminates was measured using a radiant heat tester, built according to the requirements of ISO 6942. In a typical procedure, a radiant heat source with a surface temperature of 1,710° C. was turned on and allowed to stabilise. The sample (either a laminate or a single layer) was mounted to the detector block and placed immediately behind a water-cooled shutter. The assembly was then positioned to give an exposure of 20 kW/m² on the surface of the sample when the shutter is opened. The temperature of the back of the sample was monitored until a temperature rise of at least 25° C. was measured, then the shutter closed. The thermal conductivity was calculated from the rate of temperature rise and thermal gradient across the sample, conservatively measured and assumed to be 200 K.

### Scanning Electron Microscopy (SEM) Imaging

For SEM imaging, the samples were cut using single use, Diplomat brand, PTFE coated, stainless steel injector blades (ProSciTech, Kirwan, Qld, Australia). The samples were then mounted on aluminium holders using double sided, adhesive carbon tape (ProSciTech, Kirwan, Qld, Australia), and coated with 3 nm film of a Pt/Pd alloy using a Cressington 208 HRD magnetron coater (Cressington Scientific Instruments, Watford, England). Imaging (secondary electron) of the samples was carried out using a Hitachi S4300 SE/N Field Emission Scanning Electron Microscope (Hitachi, Tokyo, Japan) with an incident beam energy of 2 kV, a nominal working distance of 10 mm, condenser lens setting of 12 and a 20 µm objective aperture in high vacuum mode.

### Stretch and Recovery Testing

A stretch and recovery test apparatus was constructed to consist of 2 speed controlled driven discs with the sample clamps mounted in slots to facilitate changing the stretch in the sample as the disc rotates. The other end of the sample was clamped in a fixed mount at the height of the axis of the disc. This mount could be moved to vary the length of the sample.

Samples from 2 mm thick skins were cut to approximately 140 mm in length and 20 mm width. The clamps were positioned such that the shortest distance between the front edges of the clamps was 90 mm and the stretch usually 100%. A small piece of silicone film was used to protect the sample in the clamps and prevent failure at the clamping point. The discs were rotated at 120 cycled per minute. The samples, run in duplicates, were repeatedly stretched and relaxed for approximately 60,000 cycles (8.5 hours) or until the sample broke. The time for the first sample to break was recorded. At the end of the testing, the length of the sample between the clamps was measured immediately after stopping and again after 60 minutes to determine the relaxation.

### Example 2 - Textile Fabrication

### Fabric 1: Knitted Leg Joint

Material: 58 Tex staple Nomex yarn,
Machine: Shima SES SWG (7 Gauge) - 3D knitting machine,
Description: Double heeled jersey knit, with expanded joint,
Purpose: To fit around the joints of the robot’s leg, permitting movement.

### Fabric 2: Body Knitted Spacer Fabric

Material: Nomex (face and back), and 300 µm Nylon 6.10 monofilament (spacer yarn),
Machine: Shima NSIG (7 Gauge),
Description: Single jersey, segmented spacer fabric, with spacer yarn separating face and back periodically. Face and back fabric joined where spacer fabric omitted to permit enhanced fabric bending,
Purpose: To fit over robot body.

### Fabric 3: Three Layer Rippled Woven Fabric

Material: 58 Tex staple Nomex yarn (face and back sides), and 40s single cotton with 40 denier lycra (inner yarn),
Machine: CCI Studio, 6 shafts,
Description: Three-layer woven structure, with Nomex on the face and back, and cotton/lycra within the fabric structure. The cotton/lycra yarn has been periodically inserted as a weft yarn to create the rippled effect. All three layers are periodically connected throughout the fabric, with the distance between these connections (measured in weft picks per inch) varied, and the density of the weft stitch within these areas (measured in weft picks per inch) varied. Fabric extension occurs in places where all three layers are not connected, permitting greater extension than an interconnected woven structure,
Purpose: To fit over robot body and legs.

TABLE 1

Interconnection parameters used for fabric 3 samples

| | Ends per inch (EPI) | Interconnecting distance Picks per inch (PPI) | Interconnecting weft density Picks per inch (PPI) |
|---|---|---|---|
| FABRIC A | 51 | 54/3 | 94 |
| FABRIC B | 51 | 32/3 | 90 |
| FABRIC C | 51 | 42/3 | 90 |

### Fabric 4: Three Layer Woven Fabric

Material: 58 Tex staple Nomex yarn (face and back sides), and Wykes 5005 stretch yarn (inner yarn),
Machine: CCI Studio, 6 shafts,
Description: This is the same as the three-layer woven structure of fabric 3, but without the cotton/lycra weft insertion. For this reason, the fabric is flat, without rippled effect. All three layers are periodically connected throughout the fabric, with the distance (measured in weft picks) between these connections varied, and the density of the weft stitch within these areas varied. Fabric extension occurs in places where all three layers are not connected, permitting greater extension than an interconnected woven structure.

TABLE 2

Interconnection parameters used for fabric 4 samples

| | Ends per inch (EPI) | Interconnecting distance Picks per inch (PPI) | Interconnecting weft density Picks per inch (PPI) |
|---|---|---|---|
| FABRIC A | 51 | 54/3 | 94 |
| FABRIC B | 51 | 32/3 | 94 |
| FABRIC C | 51 | 42/3 | 94 |

Purpose: To fit over robot body.

### Fabric 5: Three Layer Woven Fabric

Material: 58 Tex staple Nomex yarn (face and back sides), and 40s single cotton with 40 denier lycra (inner yarn),
Machine: CCI Studio, 6 shafts,
Description: This is the same as the three-layer woven structure of fabric 3. All three layers are periodically connected throughout the fabric, with the distance (measured in weft picks) between these connections varied, and the density of the weft stitch within these areas varied. Fabric extension occurs in places where all three layers are not connected, permitting greater extension than an interconnected woven structure,
Purpose: To fit over robot body.

TABLE 3

Interconnection parameters used for fabric 5 samples

| | Ends per inch (EPI) | Interconnecting distance Picks per inch (PPI) | Interconnecting weft density Picks per inch (PPI) |
|---|---|---|---|
| FABRIC A | 51 | 42/3 | 110 |
| FABRIC B | 51 | 32/3 | 102 |
| FABRIC C | 51 | 54/3 | 110 |
| FABRIC D | 51 | 42/3 | 80 |

### Fabric 6: Two Layer Woven Fabric, With Cavities

Material: 58 Tex staple Nomex yarn (face and back sides),
Machine: CCI Studio, 4 shafts,
Description: A layer fabric was woven, with face and back of Nomex that were connected intermittently to create tunnels. The distance (measured in weft picks) between these connections was varied, and the density of the weft stitch within these areas varied,

TABLE 4

Interconnection parameters used for fabric 6 samples

| | Ends per inch (EPI) | Interconnecting distance Picks per inch (PPI) | Interconnecting weft density Picks per inch (PPI) |
|---|---|---|---|
| FABRIC A | 80 | 32/2 | 48 |
| FABRIC B | 80 | 28/2 | 48 |
| FABRIC C | 80 | 24/2 | 48 |
| FABRIC D | 80 | 20/2 | 48 |
| Twill 2/2 | 80 | - | 64 |

Purpose: To fit over robot body.

### Example 3

### Silicone Layers and Thermal Conductivity

Silicone elastomers without fillers were sourced from commercial suppliers as shown iN Table 5. Most silicones were manufactured by Wacker AG, supplied in small quantities by Barnes Products Pty. Ltd. For most experiments two-part silicones without fillers were used.

TABLE 5

Silicone elastomers used and suppliers

| | | | |
|---|---|---|---|
| Silicone | Supplier | Hardness | Viscosity cps |
| M4601 | Barnes Products Pty Ltd | A28 | 20000 |
| M4642 | Barnes Products Pty Ltd | A37 | 15000 |
| M4644 | Barnes Products Pty Ltd | A40 | 50000 |
| RTV-2 | Barnes Products Pty Ltd | A28 | 20000 |
| C1200 | Barnes Products Pty Ltd | A25 | - |
| Soft Trans | Barnes Products Pty Ltd | A20 | 2500 |
| Vario 15 | Barnes Products Pty Ltd | A15 | 3000 |
| Vario 40 | Barnes Products Pty Ltd | A40 | 10000 |
| Elastosil SC 835 | Wacker | A20 | 20000 |
| TCS 7510 | Bluestar | | |

These silicones were mixed in the recommended ratio and fillers and/or additives, shown in Table 6, added as indicated in the results. The mixture was then poured into moulds to give sheets 80 mm × 230 mm with thicknesses near 2 mm, 6 mm and 10 mm.

Mixtures containing aerogels or hollow glass microsphere fillers were prepared by weighing the filler into the mixing vessel then adding the required mass of part A of the silicone. The mixture was then slowly mixed to disperse the filler into the silicone before adding the catalyst/crosslinker (Part B). Care was taken not to cause dusts during this process. Aluminium flakes, where used, were added to the silicone containing the aerogel/microsphere filler before adding Part B.

TABLE 6

Fillers and additives used

| | | |
|---|---|---|
| Filler | Supplier | Description |
| Enova IC3100 | Cabots | Aerogel particle, 2-40 µm in diameter |
| XOL-150LD | Sphere One | Hollow aluminosilicate glass microsphere, 40 µm average diameter |
| Extendosphere TG | Sphere One | Hollow ceramic microsphere, 75 µm average diameter |
| Aluminium flakes Miral 80000/A | Australian Metal Powders Pty Ltd | 20 µm aluminium flake |
| Aluminium powder | Barnes Products Pty Ltd | Powdered aluminium |
| Vazo 64G | IMCD | Blowing agent, 2,2′-azobis(isobutyronitrile) |

Most silicones were cured at room temperature for at least 48 hours before removing from the moulds. In some skins a fabric was placed in the mould before adding the silicone to give a silicone composite or a bonded layer structure.

The key results of the thermal characterisation are shown in Error! Reference source not found. where the thermal conductivity is expressed as a specific thermal resistance (i.e. m·K/W). The target thermal conductivity is 0.025 W/m·K, corresponding to a specific thermal resistance of 40 m K/W.

TABLE 7

Key specific thermal resistance results for silicone skin formulations

| Silicone | Filler [wt.%] | Thickness | Specific thermal resistance [m·K/W] |
|---|---|---|---|
| M4601 | none | 2-10 mm | 23.4 |
| | 4% aerogel | 2-10 mm | 31.0 |
| | 5% aerogel | 2-10 mm | 35.1 |
| | 4% aerogel, foil | 2-10 mm | 250 |
| | 5% XOL microspheres | 2-10 mm | 35.0 |
| | 6% XOL microspheres, Nomex spacer | 6-10 mm | 37 |
| | 5% aerogel, 10% aluminium flakes | 2-10 mm | 50 |
| | 5% XOL, 10% aluminium powder | 2-10 mm | 38 |
| | 5% XOL microspheres, foil | 2 mm | 180 |
| | Al Foil coating | 6-10 mm | 185 |
| | 5% XOL, 10% aluminium powder, Nomex spacer | 6-10 mm | 40 |
| M4642 | 1 % aerogel | 2-10 mm | 27 |
| M4644 | 5 % aerogel | 2-10 mm | No result |
| RTV-2 | 5% aerogel | 1-10 mm | 43 |
| | 5% aerogel, al flakes | 2-10 mm | 70 |
| | 5% XOL microspheres | 11 mm | 38 |
| C1200 | | | - |
| Soft Trans | | | - |
| Vario 15 | 5% XOL microspheres, al flakes | 2-10 mm | 72 |
| | 5% XOL microspheres, al foil, Nomex non-woven | 20 mm | 210 |
| Vario 40 | | | - |
| Elastosil SC 835 | No filler | 7 mm | 36 |
| TCS 7510 | No filler | 7 mm | 30 |

In the Table, “XOL” identifies white aluminosilicate multicellular hollow spheres. All silicones on their own, as expected, had significantly higher thermal conductivity than the target. The addition of 5% aerogel (Enova IC3100) reduced the thermal conductivity, with a best result of 0.028 W/m·K or a specific thermal resistance of 35.1 m·K/W. Hollow glass microspheres (XOL 150LD) gave very similar results at the same add-in but were much easier to mix with the silicone. Aerogels, being very low density required a significantly larger volume of material to give the 5% add-in, which resulted in a much lower pourability due to the higher viscosity. In many samples the silicone could not be poured into the mould or a smooth surface be obtained. Reducing the aerogel content to 4% improved the pourability but decreased the specific thermal resistance.

M4601 gave the most pliable and stretchable skin by manual handling. Other silicones were stiffer, some considerably stiffer, particularly in the thicker 6 and 10 mm skins. Due to its greater flexibility M4601 was selected for further development. The two silicone foams gave good flexibility, however the mechanical strength was low.

The addition of a reflective surface significantly improved the specific thermal resistance and decreased the outer surface temperature. Aluminium foil gave the best results at over 200 m·K/W, however when the skin was bent or stretched the film tore, which allowed local heating. To produce a flexible skin the use of aluminium flakes and powder was investigated. Aluminium flakes were much more reflective in the silicone and 10% by weight gave a specific thermal resistance greater than 50 m·K/W

RTV-2 gave better specific thermal resistance than M4601, both as a silicone with XOL 150LD microspheres (white aluminosilicate multicellular hollow spheres) as filler and with added aluminium flakes. This silicone was stiffer than M4601 and required considerably more force to stretch. It is however a better candidate for the body silicone elastomer filled with 5% XOL (white aluminosilicate multicellular hollow spheres) and 10% aluminium flakes at 70 m·K/W.

### Example 4 - Fabrication of Layered Assemblies

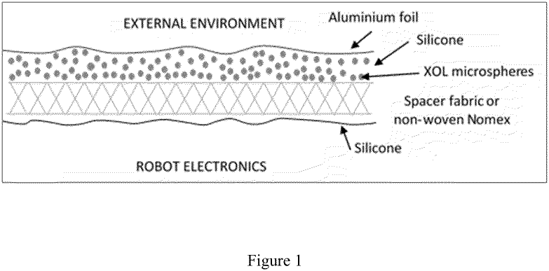

Based on the thermal conductivity results outlined in Example 3, a laminate skin was produced and tested. The basic structure of the sample laminates is shown in FIG. 1. The first skin was prepared using the knit space fabric with the outside coated with 6 to 10 mm M6401 silicone layer filled with 5% XOL (white aluminosilicate multicellular hollow spheres) 150 microspheres. This skin gave near the target specific thermal resistance at 37 m·K/W. The addition of a 2 mm thick silicone outer layer containing 10% aluminium flakes and 5% XOL (white aluminosilicate multicellular hollow spheres) microspheres to the spacer fabric improved the performance to 40 m·K/W. Further improvement was achieved by adding an inner silicone layer of 2 mm and aluminium foil to the outer surface. The resulting laminate gave a specific thermal resistance of over 200 m·K/W.

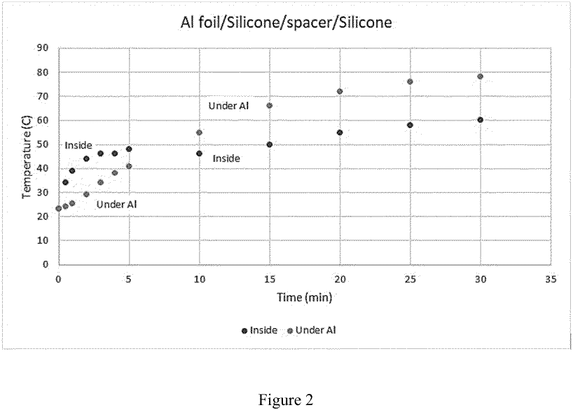

A multilayered skin (aluminium foil / 4 mm M4601 with 5% XOL (white aluminosilicate multicellular hollow spheres) / spacer fabric / 2 mm M4601 with 5% XOL) was constructed and tested by exposure to 20 kW radiant heat for up to 30 minutes. The inner surface temperature and the outer surface temperature were monitored. The corresponding temperature profiles are shown in FIG. 2. After 30 minutes the inner temperature was 60° C. and the outside temperature (measured under the foil) was 80° C.

For avoidance of doubt, the “inner” surface of the laminate (or of any layer) will be understood to be the surface of the laminate (or of any layer) not directly exposed to a heat source. The “outer” surface of the laminate (or of any layer) will be understood to be the surface of the laminate (or of any layer) that is directly exposed to a heat source. When in relation to a robotic component, the “inner” surface of the laminate will be the one on the side of the robotic component, while the “outer” surface of the laminate will be the one facing the external environment.

### Example 5

In the laminate of Example 4, the 4 mm M4601 layer containing 5% XOL microspheres (white aluminosilicate multicellular hollow spheres) was substituted with a layer of silicone foam (Elasosil SC 835), and the spacer fabric substituted with a 200 gsm lightly needled non-woven fabric.

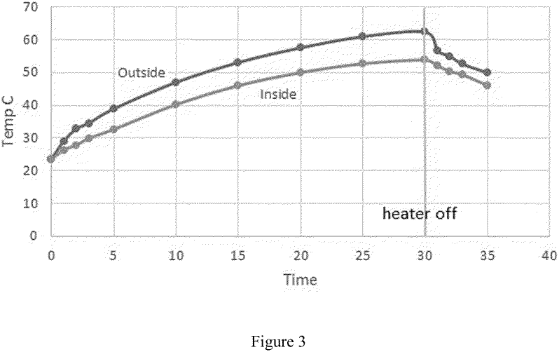

The resulting laminate showed improved thermal performance. FIG. 3 shows the temperature profiles all the inner surface and outer surface of the laminate. Overall, the laminate did not show excessive heating, however the difference between the inside and outside (under the aluminium foil) temperatures was only 10° C. This skin would be suitable for a body part of the robot and was lighter in weight than the spacer fabric skin.

### Example 6

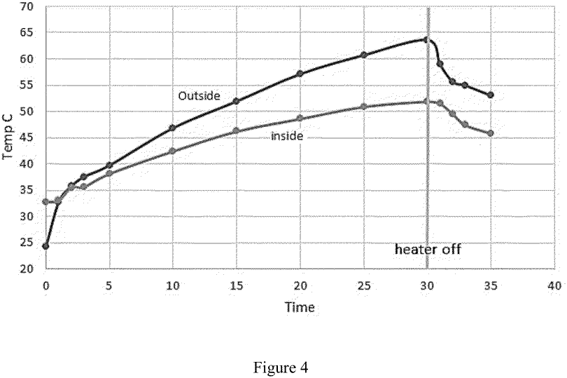

Slightly better performance was achieved using the 200 gsm lightly needled non-woven fabric with Soft Trans 15. This fabric has high bulk but is easily compressed. Skins were prepared by casting silicone sheets then assembling them into the skin. The outside was aluminium foil, on top of 6 mm soft trans 15 with 5% XOL microspheres (white aluminosilicate multicellular hollow spheres) then the non-woven fabric and 2 mm soft trans 15 with no additives. The results of exposure to 20 kW/m² radiant heat are shown in FIG. 4, with a maximum internal temperature of 54° C. after 30 minutes with an inside to outside temperature difference of 25° C.

### Example 7 (Comparative)

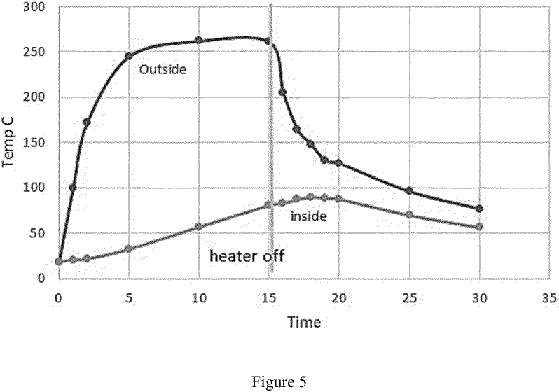

Replacing the aluminium foil with a 2 mm thick of silicone field with aluminium particles (Soft Trans 15) result in a laminate with poor control over the outside temperature relative to the inside temperature. As shown in FIG. 5, after 15 minutes exposure to 20 kW/m² radiant heat the outside temperature was measured to be above 250° C., corresponding to a maximum inside temperature in excess of 80° C., which would correspond to the tolerance limit of the robot electronics.

### Example 8

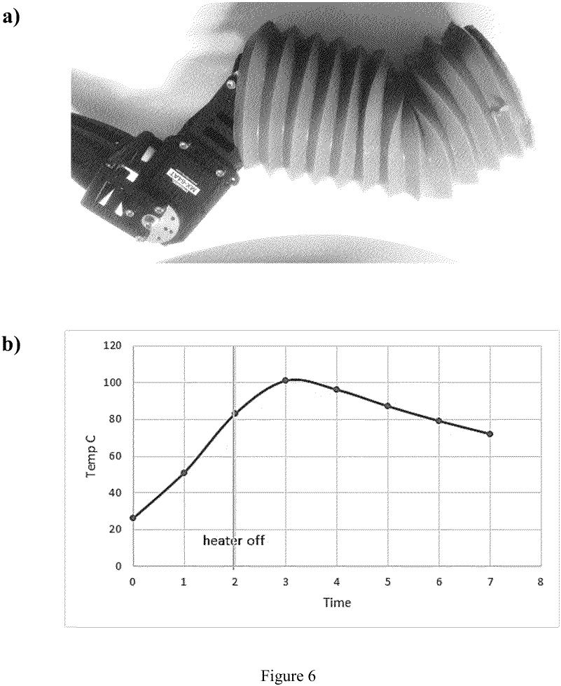

A partial laminate skin for the leg joint component of a robot was produced. A single layer made of silicone containing 10% by weight aluminium flakes and 5% by weight hollow glass microspheres was first developed. The skin was cast in a mould to give a cylindrical concertina shape (FIG. 6(a)). The layer can be shaped to have an inner diameter slightly larger than the leg component. A knitted Nomex sleeve with knee joints was fitted to the leg below the skin to give increased thermal protection.

Radiant heat tests give an inner surface temperature rises of less than 80° C. after 30 minutes exposure to 20 kW radiant source for the body skin and approximately 120° C. for the leg skin.

The silicone mixture was poured into the mould and allowed to cure for 24 hours before demoulding. Two lengths of the skin and end caps, tapered to fit the feet, were joined together using Soft Trans 15 silicone to form a leg skin.

The leg skin (FIG. 6(a)) made from 2 mm Soft Trans 15 with 5% XOL microspheres (white aluminosilicate multicellular hollow spheres) and 10% aluminium flakes had an internal temperature of approximately 140° C. and external temperature of 240° C. after 30 minutes exposure to 20 kW/m² radiant heat. If aluminium powder is used instead of aluminium flakes, the resulting laminate shows a decreased thermal barrier performance, providing increased internal temperature to over 100° C. after 3 minutes exposure to 20 kW/m² radiant heat (FIG. 6(b)).

### Example 9

The structure of foamed silicone Elastosil SC835 was investigated by SEM. Typical images are shown in FIG. 7(a). As shown in the micrographs, the silicone foam has a closed cell structure with a bubble size varying from units of mm in diameter and easily visible down to approximately 50 µm. This is generally larger than optimum for the best insulation properties.

A typical SEM image of the spacer knit fabric coated with a 2 mm thick coating of silicone is shown in FIG. 7(b). This sample was prepared by cutting the Spacer fabric to fit the bottom of the 10 mm mould then coating the fabric with silicone to fill the mould. The silicone penetrated the outer layer of the knit, giving a composite structure with an air gap and inner layer of knit. A second layer of silicone could then be coated onto the inner face of the knit to incorporate the air gap in the skin.

### EXAMPLE 10 - Robustness Testing

The robustness of the laminates produced in Example 9 were tested for by stretch and recovery cycling. In all cases 2 mm thick flat cast films were cut to size then tested at approximately 120 cycles per second. All samples, when cut with straight sides, passed more than 50,000 cycles (7 hours) at 100% stretch. To prevent the clamps cutting the sample a small piece of silicone film was used to line the clamps

Adding a small cut to the side of the sample reduced the number of cycles before the sample tore to between 5,000 and 20,000 cycles. The results are summarised in Table 8. All samples were run as duplicates and times are for the first sample to fail and to the nearest 2000 cycles or 15 minutes.

Most silicones performed as expected. They were selected from the available range for a minimum of 100% stretch and high toughness. Adding XOL microspheres (white aluminosilicate multicellular hollow spheres) and aluminium flakes or powders did not reduce the robustness of the skin.

TABLE 8

Stretch and recovery results

| Sample | Cycles to fail or stop |
|---|---|
| M4601 | >60,000 |
| M4601, 5% XOL | >60,000 |
| M4601, 5% XOL, 10% aluminium flakes | >60,000 |
| M4642, 1% aerogel | 5,000 |
| RTV-2 | >50,000 |
| RTV-2, 5% XOL | >40,000 |
| Soft Trans 15 | >60,000 |
| Soft Trans, 5% XOL | >60,000 |
| Soft Trans, 5% XOL, 10% aluminium particles | >50,000 |
| M4601 2 mm cut in edge of sample | 8,000 |
| Soft Trans 15, 5% XOL, 2 mm cut in edge of sample | 20,000 |
| RTV-2 | 5,000 |

One sample of M4642 failed in the first 45 minutes running, which may have been due to a small cut in the sample during sample preparation, however the second sample also failed after approximately 10,000 cycles. As this sample is still and has relatively low stretch it was not considered suitable for the leg skin where stretch is more important.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A heat barrier laminate for use as a skin, the laminate comprising in the following order:
a) a radiant barrier layer,
b) a heat-insulating layer comprising a first polymer,
c) a spacer layer comprising a fabric, and
d) a heat-insulating layer comprising a second polymer
wherein the first polymer and/or the second polymer comprise(s) a heat-insulating filler selected from hollow glass particles, hollow ceramic particles, hollow polymer particles, and a combination thereof.

2. The laminate of claim 1, wherein the radiant barrier layer is a metal foil.

3. The laminate of claim 2, wherein the metal foil is aluminium foil.

4. The laminate of claim 1, wherein the first polymer and the second polymer are the same polymer.

5. The laminate of claim 1, wherein the first and/or second polymer is a foamed polymer.

6. The laminate of claim 1, wherein the first polymer and/or second polymer is selected from a butyl rubber, a fluoro elastomer, natural rubber, neoprene, nitrile, polyurethane, silicone, and a combination thereof.

7. The laminate of claim 1, wherein the heat-insulating filler is selected from hollow glass microspheres, hollow ceramic microspheres, hollow polymer microspheres, and a combination thereof.

8. The laminate of claim 1, wherein the heat-insulating filler is present in an amount of about 1-10 wt% relative to the weight of the polymer.

9. The laminate of claim 1, wherein the first and/or second polymer comprises a heat-reflecting filler.

10. The laminate of claim 9, wherein the heat-reflecting filler is at least one of metal flakes and metal powder.

11. The laminate of claim 10, wherein the metal flakes are aluminium flakes, and the metal powder is aluminium powder.

12. The laminate of claim 9, wherein the heat-reflecting filler is present in an amount of about 1-20 wt.% relative to the weight of the polymer.

13. The laminate of claim 1, wherein the heat insulating layer b) and the heat-insulating layer d) have a thickness of about 8-12 mm and 1-5 mm, respectively.

14. The laminate of claim 1, wherein the fabric comprises fibres with a limiting oxygen index (LOI) greater than 21 vol%.

15. The laminate of claim 1, wherein the fabric is selected from meta-aramid fabric and para-aramid fabric.

16. The laminate of claim 1, having a total thickness of about 10-30 mm.

17. The laminate of claim 1, the laminate being flexible.

18. The laminate of claim 1, for use as a skin on a robotic component.

19. A skin for a robotic component, the skin comprising the laminate of claim 1.
